(19) United States
(12) Patent Application Publication
(10) Pub. No.: US 2007/0109554 A1
(43) Pub. Date: May 17, 2007

(54) POLARIZATION SENSITIVE OPTICAL COHERENCE DEVICE FOR OBTAINING BIREFRINGENCE INFORMATION

(76) Inventors: Felix I. Feldchtein, Cleveland, OH (US); Valentin M. Gelikonov, Nizhny (RU); Grigory V. Gelikonov, Nizhny (RU)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/559,238

(22) Filed: Nov. 13, 2006

Related U.S. Application Data
(60) Provisional application No. 60/736,534, filed on Nov. 14, 2005.

(51) Int. Cl. G01B 9/02

(52) U.S. Cl. 356/492; 356/477

(57) ABSTRACT

Polarization-sensitive optical coherence devices for obtaining birefringence information are presented. The polarization state of the optical radiation outgoing from the optical radiation source is controlled such that the polarization state of the optical radiation incident on a sample has a 45 degrees angle with respect to the anisotropy axis of the sample. A combination optical radiation is produced in a secondary interferometer by combining a sample portion with a reference portion of optical radiation reflected from a tip of an optical fiber of the optical fiber probe. Subject to a preset optical path length difference of the arms of the secondary interferometer, a cross-polarized, and/or a parallel-polarized component of the combined optical radiation, are selected. Time domain and frequency domain registration are provided. The performance of the device is substantially independent from the orientation of the optical fiber probe with respect to the sample.

### CROSS-REFERENCE TO RELATED APPLICATIONS

This application is based on and claims priority to provisional U.S. patent application Ser. No. US 60/736,534, which was filed on Nov. 14, 2005.

### BACKGROUND OF THE INVENTION

The present invention relates to systems and methods for visualizing subsurface regions of samples, and more specifically, to a polarization-sensitive common path optical coherence reflectometer (OCR) and polarization-sensitive common path optical coherence tomography (OCT) device that provides internal depth profiles and depth resolved images of samples.

Optical coherence reflectometry/tomography is known to be based on optical radiation interference, which is a phenomenon intrinsically sensitive to the polarization of the optical radiation, because parallel-polarized components produce strongest interference, while cross-polarized components do not interfere at all.

Optical coherence reflectometry/tomography involves splitting an optical radiation into at least two portions, and directing one portion of the optical radiation toward a subject of investigation. The subject of investigation will be further referred to as a “sample”, whereas the portion of optical radiation directed toward the sample will be further referred to as a “sample portion” of optical radiation. The sample portion of optical radiation is directed toward the sample by means of a delivering device, such as an optical probe. Another portion of the optical radiation, which will be further referred to as “reference portion”, is used to provide heterodyne detection of the low intensity radiation, reflected or backscattered from the sample detecting interference of the two portions and forming a depth-resolved profile of the coherence backscattering intensity from a turbid media (sample).

A well known version of optical coherence reflectometry and tomography is the “common path” version, also known as autocorrelator or Fizeau interferometer based OCR/OCT. In this version, the reference and sample portions of the optical radiation do not travel along separate optical paths. Instead, a reference reflection is created in the sample optical path by introducing an optical inhomogenuity in the distal part of the delivering device, the inhomogenuity serving as a reference reflector. Resulting from that, the reference and sample portions of the optical radiation experience an axial shift only. The distance between the reference reflector and the front boundary of the longitudinal range of interest will be considered here as “reference offset”. The entire combination of the sample portion of the optical radiation and axially shifted reference portion is combined with the replica of the same combination, shifted axially, so the reference portion of one replica has a time of flight (or optical path length) matching that of the sample portion of another replica. These portions interfere in a very similar way to the traditional “separate path” time domain optical coherence reflectometry/tomography embodiments. The interference signal is formed by a secondary interferometer, the two arms of which have an optical length difference (“interferometer offset”) equal to the reference offset. By scanning an optical delay between the two replicas, a time profile of the interference signal is obtained, which represents the in-depth profile of the coherent part of the reflected sample optical radiation. The later is substantially equivalent to the profile obtained in traditional separate path embodiments.

Common path reflectometry/tomography has a lot of intrinsic advantages over separate path reflectometry/tomography. These advantages are based on the fact that reference and sample portions of the optical radiation propagate in the same optical path and therefore experience substantially identical delay, polarization distortions, optical dispersion broadening, and the like. Therefore, the interference fringes are insensitive to the majority of the probe properties, including the optical fiber probe length, dispersion properties and polarization mismatch. In separate path reflectometry/tomography, the length and dispersion of the sampling arm should be closely matched with the reference arm and the polarization mismatch should be prevented (using PM fiber or other means) or compensated (using polarization diversity receiver or other means).

In addition, a well known drawback for known techniques is that the visibility of the birefringence related in-depth fringe pattern strongly depends on the orientation of the incident optical radiation beam with respect to the orientation of the anisotropy axis of an associated sample. For a biotissue, the orientation of the anisotropy axis of an associated sample is typically the orientation of connective tissue or muscle fibers. As will be appreciated by those skilled in the art, when this type of polarization-sensitive OCR/OCT is used to assess or measure birefringence in a sample, the polarization of the optical radiation incident on an associated sample should not be parallel or orthogonal to the orientation of the anisotropy axis of an associated sample. Otherwise even in the presence of strong birefringence, the in-depth fringe pattern cannot be observed. In practice, a qualified researcher using this type of polarization-sensitive OCR/OCT in laboratory conditions can manually achieve a required orientation of the device delivering optical radiation to the associated sample, enabling observation of the in-depth fringe pattern. However, it takes additional time and efforts, and may be impractical for in vivo clinical applications and for some industrial applications.

Thus, there exists a need for a polarization-sensitive optical coherence device for obtaining birefringence information that overcomes the limitations of previously known OCR/OCT devices.

Thus, there exists a need for a polarization-sensitive optical coherence device for obtaining birefringence information, the performance of which is not dependent on the orientation of the polarization of the incident optical radiation with respect to an associated sample.

A need also exists for a polarization-sensitive optical coherence device for obtaining birefringence information, which is efficient for use in clinical and industrial applications.

A need further exists for a polarization-sensitive optical coherence device for obtaining birefringence information, which is capable of being implemented with any type of known OCR/OCT topology, such as separate path topology, common path topology, or any modifications thereof.

### SUMMARY OF THE INVENTION

In accordance with the subject application, there is provided an improved polarization-sensitive optical coherence device for obtaining birefringence information that overcomes the limitations of previously known OCR/OCT devices.

Further, in accordance with the subject application, there is provided a polarization-sensitive optical coherence device for obtaining birefringence information, the performance of which is not dependent on the orientation of the polarization of the incident optical radiation with respect to an associated sample.

Still further, in accordance with the subject application, there is provided a polarization-sensitive optical coherence device for obtaining birefringence information, which is capable of being implemented with any type of known OCR/OCT topology, such as separate path topology, common path topology, or any modifications thereof.

Yet further, in accordance with the subject application, there is provided a polarization-sensitive optical coherence device for obtaining birefringence information, which is capable of being implemented with time domain, as well as frequency domain registration.

According to one embodiment of the subject application, there is provided a polarization-sensitive optical coherence device for obtaining birefringence information that includes a source of an optical radiation, polarization state controlling means, and an optical coherence reflectometer. The source of optical radiation is selected from the group consisting of: a source of polarized optical radiation, a source of partially-polarized optical radiation, and a source of non-polarized optical radiation coupled with a polarizer. The optical coherence reflectometer includes a delivering device adapted for delivering the optical radiation incident on an associated, specified by an anisotropy axis. The source of optical radiation, the optical coherence reflectometer, and the polarization state controlling means are located along an optical path. The polarization state controlling means is located between the source of optical radiation and the delivering device.

The polarization state controlling means is adapted for repeatedly switching a polarization state of the optical radiation incident on an associated sample from one state to another state such that at least one of the two polarization states of the optical radiation incident on an associated sample is other than: linear and substantially parallel to the anisotropy axis, and linear and substantially orthogonal to the anisotropy axis of an associated sample. The optical coherence reflectometer is adapted for selecting of at least one of the following polarization components of an optical radiation representative of an optical radiation having returned from an associated sample: a cross-polarized component, and a parallel-polarized component.

In a preferred embodiment, the polarization state controlling means is a polarization switch. The polarization switch is capable of being implemented as an electro-optical polarization switch, a magneto-optical polarization switch, a piezofiber polarization switch, and the like.

In one embodiment, the optical coherence reflectometer is a separate path optical coherence reflectometer. In another embodiment the optical coherence reflectometer is a common path optical coherence reflectometer. In these embodiments, time domain registration, as well as frequency domain registration is capable of being provided.

According to another aspect of the subject application, the optical coherence reflectometer further includes means adapted for changing relative positions of the optical radiation beam being delivered to an associated sample, and an associated sample, and wherein the optical coherence reflectometer is part of a device for optical coherence tomography.

Still other objects and aspects of the present invention will become readily apparent to those skilled in this art from the following description wherein there are shown and described preferred embodiments of this invention, simply by way of illustration of the best modes suited for to carry out the invention. As it will be realized by those skilled in the art, the invention is capable of other different embodiments and its several details are capable of modifications in various obvious aspects all without departing from the scope of the subject application. Accordingly, the drawings and description will be regarded as illustrative in nature and not as restrictive.

### BRIEF DESCRIPTION OF DRAWINGS

For a more complete understanding of the present invention and the advantages thereof, reference is now made to the following description taken in conjunction with the accompanying drawings, in which:

FIG. 1 is a block diagram of one preferred embodiment of a polarization-sensitive optical coherence device for obtaining birefringence information in accordance with the subject application.

### DETAILED DESCRIPTION OF THE INVENTION

The subject application is directed to systems and methods for visualizing subsurface regions of samples, and more specifically, to a polarization-sensitive optical coherence device for obtaining birefringence information that is capable of providing internal depth profiles and depth images of samples. Modifications of the polarization-sensitive optical coherence device of the subject application are illustrated by means of examples of optical fiber devices being part of an apparatus for optical coherence tomography, although it is evident that they may be implemented with the use of bulk optic elements, and may be used as independent devices. The optical fiber implementation is preferable for use in medical applications, especially in endoscopy, where flexibility of the optical fiber provides convenient access to different tissues and organs, including internal organs via an endoscope.

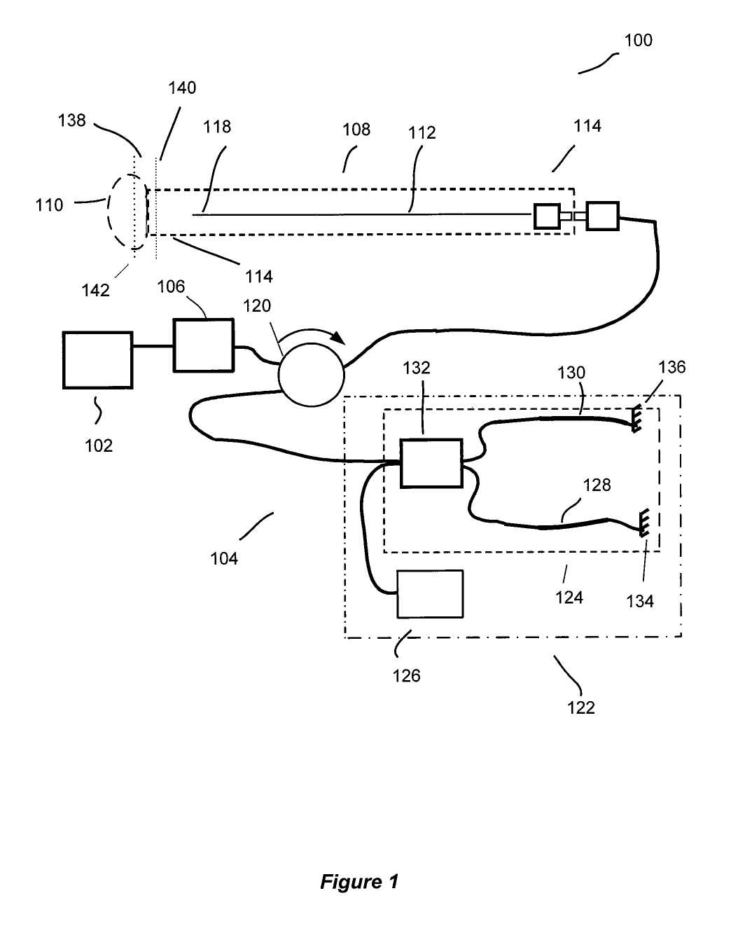

Turning now to FIG. 1, there is shown a block diagram of a preferred embodiment of a polarization-sensitive optical coherence device 100 for obtaining birefringence information in accordance with the subject application. As shown in FIG. 1, the device 100 includes a source 102 of optical radiation, an optical coherence reflectometer 104 and polarization state controlling means, placed along one optical path. The source 102 of optical radiation is selected from the group consisting of: a source of polarized optical radiation, a source of partially-polarized optical radiation, and a source of non-polarized optical radiation coupled with a polarizer. In a preferred embodiment, the source 102 operates in the visible or near IR range. A skilled artisan will appreciate that the source 102 is, for example, and without limitation, a semiconductor superluminescent diode, solid state and fiberoptic femtosecond laser, and the like. Those skilled in the art will recognize that the optical radiation includes two cross-polarized polarization components. In the embodiment of FIG. 1, the polarization state controlling means is implemented as a polarization switch 106.

The optical coherence reflectometer 104 includes a delivering device adapted for delivering the optical radiation to an associated sample 110. In the embodiment of FIG. 1, the delivering device is implemented as an optical fiber probe 108. As will be recognized by those skilled in the art, illustrated in FIG. 1 is a one channel common path optical coherence reflectometer 104 adapted for selecting a parallel-polarized component of an optical radiation representative of an optical radiation having returned from an associated sample 110. However, it will be evident to those skilled in the art, that the optical coherence reflectometer 104 is capable of being implemented as any common path or separate path optical coherence reflectometer known in the art. The optical coherence reflectometer 104 is also capable of being implemented as any embodiment described in a co-pending patent application “Polarization sensitive common path optical coherence reflectometry/tomography device” based on and claiming priority to the provisional U.S. patent application Ser. No. U.S. 60/736,534, which is incorporated herein by reference.

The optical coherence reflectometer 104 is further capable of being a one-channel arrangement adapted for selecting a cross-polarized component of an optical radiation representative of an optical radiation having returned from an associated sample 110. The optical coherence reflectometer 104 is also capable of being a two-channel arrangement adapted for selecting both a cross-polarized component, and a parallel-polarized component of an optical radiation representative of an optical radiation having returned from an associated sample 110.

In the embodiment of FIG. 1, the optical fiber probe 108 includes an optical fiber 112 extending therethrough. The optical fiber probe 108 includes a proximal part 114 and a distal part 116. The distal part 116 of the optical fiber probe 108 includes a reference reflector. In the embodiment of FIG. 1, a tip 118 of the optical fiber 112 placed in the distal part 116 of the optical fiber probe 108 is adapted for performing a function of the reference reflector. However, it will be evident to a skilled artisan that the delivering device as a whole, as well as the reference reflector being part to the delivering device, are capable of any other suitable implementations known in the art.

The optical fiber probe 108 is further adapted for producing a combined optical radiation representative of an optical radiation having returned from an associated sample 110. Those skilled in the art will appreciate that the combined optical radiation is a combination of an optical radiation having returned from an associated sample 110 and of an optical radiation reflected from the tip 118 of the optical fiber 112.

Those skilled in the art will recognize that the polarization switch 106 is suitably placed on the optical path between the source of optical radiation 102 and the delivering device. In the embodiment illustrated in FIG. 1, the polarization switch 106 is placed between the source of optical radiation 102 and the directional element 120. As will be appreciated by those skilled in the art, the polarization switch 106 is not necessarily placed between the source of optical radiation 102 and the directional element 120. The polarization switch 106 is capable of other locations on the optical path between the source of optical radiation 102 and the delivering device. As will be apparent to a skilled artisan, the suitable location of the polarization switch 106 depends also on the topology of the reflectometer 104. However, in all embodiments, the polarization switch 106 is adapted for repeatedly switching a polarization state of the optical radiation incident on an associated sample 110 from one state to another state, such that at least one of the two polarization states of the optical radiation incident on an associated sample 110 is other than: linear and substantially parallel to the anisotropy axis, and linear and substantially orthogonal to the anisotropy axis of an associated sample 110.

For example and without limitation, the polarization switch 106 is capable of repeatedly introducing a 45 degree phase shift between its own eigen polarization modes, such as linear or circular, depending on the type of the polarization switch 106 used. As will be recognized by those skilled in the art, the polarization switch 106 is capable of being implemented as any suitable polarization switch known in the art, such as, for example and without limitation, an electro-optical polarization switch, magneto-optical polarization switch, piezofiber polarization switch, electro-mechano-optical polarization switch employing mechanical movement of an optical element, and the like.

Further included in the reflectometer 104, as shown in FIG. 1, is a directional element 120 optically coupled with the polarization switch 106 and optically coupled with the proximal part 114 of the optical fiber probe 108. The directional element 120 is adapted for directing optical radiation to the optical fiber probe 108. A skilled artisan will appreciate that directional element 120 is capable of being implemented as any suitable directional element known in the art, such as, for example and without limitation, a suitable circulator or directional coupler.

The optical coherence reflectometer 104 further includes optoelectronic selecting means 122 optically coupled with the directional element 120. The optoelectronic selecting means 122 includes optical means 124 optically coupled with optoelectronic registering means 126. In the embodiment illustrated in FIG. 1, the optical means 124 is adapted for splitting the combined optical radiation, incoming from the optical fiber probe 108 through the directional element 120, into two parts of the optical radiation propagating therethrough with a preset optical path length difference, and further recombining the two parts of the optical radiation.

In the embodiment shown in FIG. 1, the optical means 124 includes an optical path 128, an optical path 130, and a polarization insensitive element 132 adapted for splitting the combined optical radiation, incoming from the optical fiber probe 108 through the directional element 120, into two parts of the optical radiation and thereafter recombining the two parts of the optical radiation having propagated along respective optical paths 128, 130 in a forward and backward direction. Those skilled in the art will appreciate that the polarization insensitive element 132 is capable of any suitable implementation known in the art, such as, for example and without limitation, a 3dB directional coupler. The optical paths 128, 130 in the optical means 124 include a Faraday mirror 134, 136, respectively, at their ends. The optical paths 128, 130 have a preset optical path length difference for the two parts of the optical radiation. As will be recognized by those skilled in the art, the optical means 124 is suitably capable of being implemented, for example and without limitation, as a suitable Michelson interferometer, as illustrated in FIG. 1, the optical paths 128, 130 being the arms of the Michelson interferometer. The optical paths 128, 130 are capable of including suitable delay elements, for example and without limitation, PZT delay elements (not shown in the drawing).

As will be explained in greater detail below, the optoelectronic registering means 126 is capable of being implemented as time domain optoelectronic registering means including a data processing and displaying unit (not shown in FIG. 1). In this embodiment, the optical means 124 includes means adapted for changing the optical path length difference for the two parts of the optical radiation (not shown in FIG. 1), such as PZT elements. The optoelectronic registering means 126 is also capable of being implemented as a frequency domain optoelectronic registering means. Those skilled in the art will appreciate, that when the optoelectronic registering means 126 is a frequency domain optoelectronic registering means, the source 102 of optical radiation is capable of being narrowband and tunable, whereas the frequency domain optoelectronic registering means 126 includes at least one photodetector connected with a processing and displaying unit (not shown in FIG. 1). In another embodiment the source 102 is broadband and implemented as a low-coherence source of optical radiation. In this embodiment a spectrometer instead of a single photodiode is used in the frequency domain optoelectronic registering means 126, therefore parallel registration is performed instead of sequential.

A slow delay line suitably adapted to control the axial position of the observation zone is capable of being introduced in any of the arms of the optical means 124 (not shown in FIG. 1).

As will be recognized by those skilled in the art, the reflectometer 104 of the subject application is specified by a longitudinal range of interest 138 at least partially overlapping with an associated sample 110. The longitudinal range of interest 138 has a proximal boundary 140 and a distal boundary 142. The reflectometer 104 of the subject application is still further specified by an optical path length difference of a first value for an optical radiation beam propagating to the reference reflector (the tip 118 of the optical fiber 112) and to the proximal boundary 140 of the longitudinal range of interest 138. The reflectometer 104 of the subject application is yet further specified by an optical path length difference of a second value for the optical radiation beam propagating to the reference reflector (the tip 118 of the optical fiber 112) and to the distal boundary 142 of a longitudinal range of interest 138.

Preferably, a regular single mode optical fiber is used in the embodiment of the reflectometer 104 of the subject application, as depicted in FIG. 1. Those skilled in the art will further appreciate at least one polarization controller is preferably included in the polarization-sensitive optical coherence device 100 between the source of optical radiation 102 and the polarization switch 106.

In accordance with another aspect of the invention, the embodiment of FIG. 1 is capable of further including means adapted for changing relative positions of the optical radiation beam being delivered to an associated sample 110, and the associated sample 110 (not shown in the drawing). In this embodiment, the optical coherence reflectometer illustrated in FIG. 1, is part of a device for optical coherence tomography. Those of ordinary skill in the art will recognize, that in this devices the means for changing relative positions of the optical radiation beam being delivered to the associated sample 110, and the associated sample 110 is suitably capable of being implemented in any way known in the art, for example and without limitation, as a lateral scanner incorporated into the optical fiber probe 108, or as an element for changing the position of an associated sample 110.

Referring now to operation of the polarization sensitive optical coherence device 100 in accordance with the present invention, shown in FIG. 1, the operation of the device 100 commences by placing the delivering device, preferably implemented as the optical fiber probe 108, at a predetermined position with respect to an associated sample 110. Depending basically on the tasks performed, the optical fiber probe 108 is placed in the vicinity of an associated sample 110, in contact with an associated sample 110, or at a predetermined distance from an associated sample 110. In all cases, there exists a distance between the tip 118 of the optical fiber 112, the tip 118 serving as a reference reflector, and the proximal boundary 140 of the longitudinal range of interest 138, which will be referred to hereinafter as an optical path length of a first value (reference offset). The distance between the tip 116 of the optical fiber 110 and the distal boundary 140 of the longitudinal range of interest 136, will be referred to hereinafter as an optical path length of a second value. Hence, in the preferred embodiment the tip 116 of the optical fiber 110 is positioned at a distance having a first optical length value from the proximal boundary 138 of the longitudinal range of interest 136 (reference offset), or, in other words, having a second optical length value from the distal boundary 140 of the longitudinal range of interest 136.

Next, an optical radiation from the source 102 is directed to the polarization switch 106. In an exemplary embodiment, the polarization switch 106 repeatedly introduces a phase shift between its own eigen polarization modes, such as linear or circular, depending on the type of the polarization switch 106 used. As will be appreciated by one skilled in the art, the polarization switch 106 is repeatedly turned “on” and “off”. When the polarization switch 106 is turned “on”, the two eigen polarization modes of the polarization switch 106 experience a relative 45 degree phase shift. Those skilled in the art will appreciate that the relative 45 degree phase shift is preferable for best fringe visibility, since, as will be explained in detail below, it leads to a corresponding polarization state of the optical radiation incident on an associated sample 110. However, reference to the 45 degree phase shift is for example purposes only, and is not to be considered a limitation in the scope of the present invention. As will be apparent to those skilled in the art, responsive to the repeatedly introduced relative 45 degree phase shift between the own eigen polarization modes of the polarization switch 106 the polarization state of the optical radiation propagating through the polarization switch 106, repeatedly changes too.

The optical radiation outgoing from the polarization switch 106 enters the optical fiber probe 108 through the directional element 120. The optical fiber probe 108 is adapted for forming and delivering an optical radiation beam to an associated sample 110. Those skilled in the art will recognize that the polarization state of the optical radiation incident on the associated sample 110 is different from that of the optical radiation, entering the directional element 120, since in a general case it experiences a random polarization change while propagating through the elements of the device 100. When the polarization state of the optical radiation incident on the associated sample 110 happens to be linear, or close to linear, its polarization orientation, generally speaking, is capable of being parallel or orthogonal to the anisotropy axis of an associated sample 110, or close to these states. As mentioned above, the latter results in invisibility or low contrast of the birefringence related fringes.

In the present exemplary embodiment, the repeatedly introduced 45 degree phase shift between the eigen polarization modes of the polarization switch 106 results in a corresponding repeatedly switching of the optical radiation incident on the associated sample 110, such as, for example and without limitation, from a linear polarization state to a circular polarization state. In another exemplary embodiment, the repeatedly introduced phase shift between the eigen polarization modes of the polarization switch 106 may result, for example, in a corresponding repeatedly switching of the optical radiation incident on the associated sample 110 from a linear state with one orientation to a linear state with another orientation. However, as will be recognized by those skilled in the art, in all circumstances for at least one position (“on” or “off”) of the polarization switch 106, the polarization states of the optical radiation incident on an associated sample 110 is other than: linear and substantially parallel to the anisotropy axis, and linear and substantially orthogonal to the anisotropy axis of an associated sample 110.

Another part of the optical radiation beam that enters the optical fiber probe 108 does not reach an associated sample 110, but is instead reflected at the tip 118 of the optical fiber 112 of the optical fiber probe 108, at some distance from an associated sample 110 (the reference portion). The optical radiation returning from the optical fiber probe 108 is a combination of the reference portion and the reflected or backscattered sample portion, shifted axially. The polarization state relationship between respective portions of optical radiation does not change as the replicas propagate through the optical fiber probe 108, since all portions of the optical radiation propagate through the same optical path. This combined optical radiation is directed through the directional element 120 to the optical means 124, which is part to the optoelectronic selecting means 122. The directional element 120, the same as the optical fiber probe 108, has no influence on the polarization state relationship between respective portions of optical radiation.

The element 132 of the optical means 122 splits the combined optical radiation, incoming from the optical fiber probe 108 through the directional element 120, into two parts of the optical radiation. In other words, the sample portion of the optical radiation, incoming from the optical fiber probe 108, is split into two parts by the element 132, and the reference portion of the optical radiation incoming from the optical fiber probe 108, is split into two parts by the element 132. As mentioned previously, in the optical means 124, which in the embodiment depicted in FIG. 1 is implemented as a Michelson optical interferometer, a regular single mode optical fiber is used, which does not maintain the initial polarization state of the optical radiation. Hence, a random polarization change occurs in the optical paths 128, 130 for all portions of the optical radiation. However, the random polarization change for all portions of the optical radiation is completely compensated after the portions of the optical radiation are reflected from respective Faraday mirrors 134, 136, which provide a 90 degree polarization rotation for any incident optical radiation. That means that the reference and sample portions of optical radiation when returning to the element 132 from the optical paths 128, 130 will continue to have the same polarization state relationship as they had, entering the element 132 from the directional element 120.

In the embodiment illustrated in FIG. 1, the optoelectronic selecting means 122 is adapted for selecting a parallel-polarized component of the combined optical radiation representative of an optical radiation having returned from an associated sample 110. Hence, the part of the reference portion of optical radiation propagating along the optical path 128 will interfere with the part of the sample portion of optical radiation propagating along the optical path 130, and visa versa.

Depending on the value of the preset optical path length difference for the parts of the optical radiation propagating along respective optical paths 128, 130, frequency domain or time domain registration is capable of being provided. As mentioned above, the reflectometer 104 of the subject application is specified by an optical path length difference of a first value for an optical radiation beam propagating to the reference reflector (the tip 118 of the optical fiber 112) and to the proximal boundary 140 of the longitudinal range of interest 138. The reflectometer 104 is further specified by an optical path length difference of a second value for the optical radiation beam propagating to the reference reflector (the tip 118 of the optical fiber 112) and to the distal boundary 142 of a longitudinal range of interest 138.

Thus, in an embodiment adapted for time domain registration, the value of the optical path length difference for the two parts of the optical radiation propagating through the optical means 124 (the interferometer offset) is set substantially equal to the first value (the reference offset). In this embodiment, the optical means 124 includes means adapted for changing the optical path length difference for the two parts of the optical radiation (not shown in the drawing), for obtaining the in-depth profile of the reflected sample portion of the optical radiation. Thus, a combination optical radiation, responsive to a portion of the reflected or backscattered optical radiation that is not depolarized by the associated sample 110, is registered by the optoelectronic registering means 126. As will be appreciated by a skilled artisan, the depolarized portion of the optical radiation reflected or backscattered from the associated sample 110 does not produce interference fringes and is not registered.

As mentioned above, the polarization switch 106 employs a procedure of repeatedly introducing a 45 degree rotation of the polarization state of the optical radiation incident on the associated sample 110. That is, for one time instance the polarization switch 106 is turned “on”, and for a subsequent time instance the polarization switch 106 is turned “off”. Those skilled in the art will appreciate that due this procedure, for subsequent given time instances, the optoelectronic registering means 126 will register the in-depth profile of the reflected sample portion of the optical radiation corresponding to the “on” and “off” positions of the polarization switch 106.

As mentioned above, the in-depth profile of the reflected sample portion of the optical radiation is capable of being reliably obtained only when the polarization of the optical radiation incident on an associated sample 110 is not parallel or orthogonal to the orientation of the anisotropy axis of an associated sample 110. Hence, as will be appreciated by those skilled in the art, at least for one of the two subsequent given time instances, good contrast for the phase retardation fringes will be reliably obtained.

In an embodiment adapted for time domain registration, the value of the optical path length difference for the two parts of the optical radiation propagating through the optical means 124 (the interferometer offset) is selected from the group consisting of: less than the first value, and exceeds the second value. The interferometer offset is capable of being adjusted in the process of assembling the optical means 124. As will be recognized by those skilled in the art, the value of the interferometer offset being less than the reference offset, or exceeding the distance from the reference reflector 118 to the distal boundary 142 of the longitudinal range of interest 138, nonetheless stays in the vicinity of the value of the reference offset. The optical spectrum of the combination optical radiation has all necessary information about the in-depth coherent reflection profile by including a component that is Fourier conjugate of the in-depth profile of the associated sample 110. Thus, the profile is extracted from Fourier transformation of the optical spectrum of the combined optical radiation by the data processing and displaying unit of the frequency domain optoelectronic registering unit 126. No depth ambiguity problem arises since the optical path difference for the interfering reference and any part of sample portion belonging to the longitudinal range of interest 138 for the two parts of the optical radiation is not reduced to zero.

In another embodiment, the value of the optical path length difference for the two portions of the optical radiation in the optical means 124 is set between the first and second values. In this embodiment, at least one of the optical paths 128, 130, preferably, includes a device for eliminating mirror ambiguity, DC artifacts, and autocorrelation artifacts. One skilled in the art will recognize that such means are well known in the art, and any such means is capable of being suitably included in at least one of the optical paths 128, 130. For example and without limitation, a phase modulator or a frequency modulator advantageously included in one of the optical paths 128, 130 of the optical means 124 (not shown in the drawing), substantially eliminates mirror ambiguity, DC artifacts, and autocorrelation artifacts, and improves the SNR of the reflectometer 104 of the subject application, as well.

As will be recognized by those skilled in the art, the embodiments described above employ a point measurement of the birefringence/retardation profile, typically known as an A-mode operation. In this mode, no lateral scanning is performed and only a raw or averaged in-depth profile is displayed and/or recorded. The same is true when just a number, characterizing, for example, the average birefringence value is of interest. In this embodiment, a very simple, compact and cost effective optical fiber probe 108 is capable of being used for the A-mode operation (also known as low coherence reflectometry). The optical fiber probe 108 is capable of being made as small as a fraction of a millimeter in diameter and can reach anatomic areas which otherwise are not accessible (like spinal disks). Such a probe is capable of suitably being made disposable.

When a B-mode operation is of interest (OCT imaging), which implements lateral scanning, the device 100, as mentioned above, includes means for changing relative positions of the optical radiation beam being delivered to an associated sample 110, and the associated sample 110 (not shown in the drawing). Otherwise, the device 100 operates in the same manner, as described above for operating in an A-mode. As will be apparent to a skilled artisan, for OCT image acquisition, one frame (B-mode) is capable of being acquired with the polarization switch 106 being in an “off” position, and another with the polarization switch 106 being in an “on” position, at least one of the frames ensuring good contrast.

As will be further appreciated by those skilled in the art, signals acquired in “on” and “off” positions of the polarization switch 106, can be combined to form one A- or B-frame with enhanced visibility of the polarization retardation pattern. Generally speaking, it is difficult to perform the procedure without any a priori knowledge of this pattern spatial scale, but in many cases (like in cartilages) the range of expected birefringence is known and therefore the characteristic spatial scale of the fringe pattern is known as well. Then the existence of such scale fringes can be detected by Fourier or wavelet transform and this information can be used to properly combine “on” and “off” components (as well as any combinations of those with “parallel” and “orthogonal”polarizations) for better contrast/visibility of the fringe pattern or for fully automated measurement of the birefringence.

What is claimed is:

1. A polarization sensitive optical coherence device for obtaining birefringence information comprising:
a source of optical radiation;
an optical coherence reflectometer including a delivering device adapted for delivering an optical radiation incident on an associated sample, specified by an anisotropy axis; and
polarization state controlling means;
wherein the source of optical radiation, the optical coherence reflectometer, and the polarization state controlling means are located along an optical path;
wherein the polarization state controlling means is located between the source of optical radiation and the delivering device; and
wherein the polarization state controlling means is adapted for repeatedly switching a polarization state of the optical radiation incident on an associated sample from one state to another state such that at least one of the two polarization states of the optical radiation incident on an associated sample is other than: linear and substantially parallel to the anisotropy axis, and linear and substantially orthogonal to the anisotropy axis of an associated sample; and
wherein the optical coherence reflectometer is adapted for selecting of at least one of the following polarization components of an optical radiation representative of an optical radiation having returned from an associated sample: a cross-polarized component, and a parallel-polarized component.

2. The polarization sensitive optical coherence device of claim 1 wherein the polarization state controlling means is a polarization switch.

3. The polarization sensitive optical coherence device of claim 2 wherein the polarization switch is an electro-optical polarization switch.

4. The polarization sensitive optical coherence device of claim 2 wherein the polarization switch is a magneto-optical polarization switch.

5. The polarization sensitive optical coherence device of claim 2 wherein the polarization switch is a piezofiber polarization switch.

6. The polarization sensitive optical coherence device of claim 1 wherein the optical coherence reflectometer is a separate path optical coherence reflectometer.

7. The polarization sensitive optical coherence device for birefringence measurements of claim 6 wherein the separate path optical coherence reflectometer is further adapted for providing one of the following: time domain registration, and frequency domain registration.

8. The polarization sensitive optical coherence device for birefringence measurements of claim 1 wherein the optical coherence reflectometer is a common path optical coherence reflectometer.

9. The polarization sensitive optical coherence device of claim 8 wherein the common path optical coherence reflectometer is further adapted for providing one of the following: time domain registration, and frequency domain registration.

10. The polarization sensitive optical coherence device of claim 1 wherein the optical coherence reflectometer further includes means adapted for changing relative positions of the optical radiation beam being delivered to an associated sample, and an associated sample, and wherein the optical coherence reflectometer is part to a device for optical coherence tomography.

11. The polarization sensitive optical coherence device of claim 1 wherein the source of optical radiation is selected from the group consisting of: a source of polarized optical radiation, a source of partially-polarized optical radiation, and a source of non-polarized optical radiation coupled with a polarizer.
